(19) United States
(12) Patent Application Publication
(10) Pub. No.: US 2015/0036352 A1
(43) Pub. Date: Feb. 5, 2015

(54) LIGHT EMITTING DIODE LAMP AND DIFFUSING CAP THEREOF

(71) Applicant: WINTEK CORPORATION, Taichung City (TW)

(72) Inventors: Ming-Chuan Lin, Taichung City (TW); Zhi-Ting Ye, Miaoli County (TW); Hung-Pin Chang, Taichung City (TW); Wen-Chieh Wu, New Taipei City (TW)

(73) Assignee: WINTEK CORPORATION, Taichung City (TW)

(21) Appl. No.: 13/957,466

(22) Filed: Aug. 2, 2013

(51) Int. Cl. F21V 7/04

(52) U.S. Cl. CPC F21V 7/04; F21V 7/041
USPC 362/307

(57) ABSTRACT

A light emitting diode (LED) lamp is provided. The LED lamp includes a circuit board, at least one LED, a diffusing cap and a heat sink structure. The LED is disposed on the circuit board for emitting a light. The diffusing cap covers the LED and the circuit board. The diffusing cap includes an outer emitting portion and a lateral emitting portion. The outer emitting portion has a concave. The lateral emitting portion is connected to the outer emitting portion. The concave is used for reflecting part of the light toward a lateral surface of the lateral emitting portion. The heat sink structure is disposed below the circuit board for dissipating a heat generated from the LED and the circuit board.

### BACKGROUND

1. Technical Field

The disclosure relates in general to a lamp and a diffusing cap thereof, and more particularly to a light emitting diode (LED) lamp and a diffusing cap thereof.

2. Description of the Related Art

Along with the advance in technology, various types of lamps are provided. For example, incandescent lamps, fluorescent lamps and light emitting diode (LED) lamps are widely used in our daily life.

LED is a semiconductor light source. LEDs are used in lamps in many devices and are increasingly used for other lighting. When a LED is switched on, electrons are able to recombine with holes within the device, releasing energy in the form of photons.

LED has high directivity, so the emission angle of the LED lamp is small. For being used in house or office, the emission angle of the LED lamp should be enlarged to widely illuminate the environment.

### SUMMARY

The disclosure is directed to a light emitting diode (LED) lamp and a diffusing cap thereof. The diffusing cap is designed to have a concave for enlarging the emission angle of the LED lamp.

According to a first aspect of the present disclosure, a light emitting diode (LED) lamp is provided. The LED lamp includes a circuit board, at least one LED, a diffusing cap and a heat sink structure. The LED is disposed on the circuit board for emitting a light. The diffusing cap covers the LED and the circuit board. The diffusing cap includes an outer emitting portion and a lateral emitting portion. The outer emitting portion has a concave. The lateral emitting portion is connected to the outer emitting portion. The concave is used for reflecting part of the light toward a lateral surface of the lateral emitting portion. The heat sink structure is disposed below the circuit board for dissipating a heat generated from the LED and the circuit board.

According to a second aspect of the present disclosure, a diffusing cap is provided. The diffusing cap is used in a light emitting diode (LED) lamp. The diffusing cap includes an outer emitting portion and a lateral emitting portion. The outer emitting portion has a concave. The lateral emitting portion is connected to the outer emitting portion. The concave is used for reflecting part of a light emitted from at least one LED toward a lateral surface of lateral emitting portion.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a light emitting diode (LED) lamp according to a first embodiment.

FIG. 2 shows a cross section view of a diffusing cap in FIG. 1.

FIG. 3 shows a light intensity plot of the LED lamp in FIGS. 1 and 2.

FIG. 4 shows a light emitting diode (LED) lamp according to a second embodiment.

FIG. 5 shows a cross section view of a diffusing cap in FIG. 5.

### DETAILED DESCRIPTION

Preferred embodiments are disclosed below for elaborating the invention. A diffusing cap is designed to have a concave for enlarging the emission angle of a LED lamp. The following embodiments are for the purpose of elaboration only, not for limiting the scope of protection of the invention. Besides, secondary elements are omitted in the following embodiments to highlight the technical features of the invention.

### First Embodiment

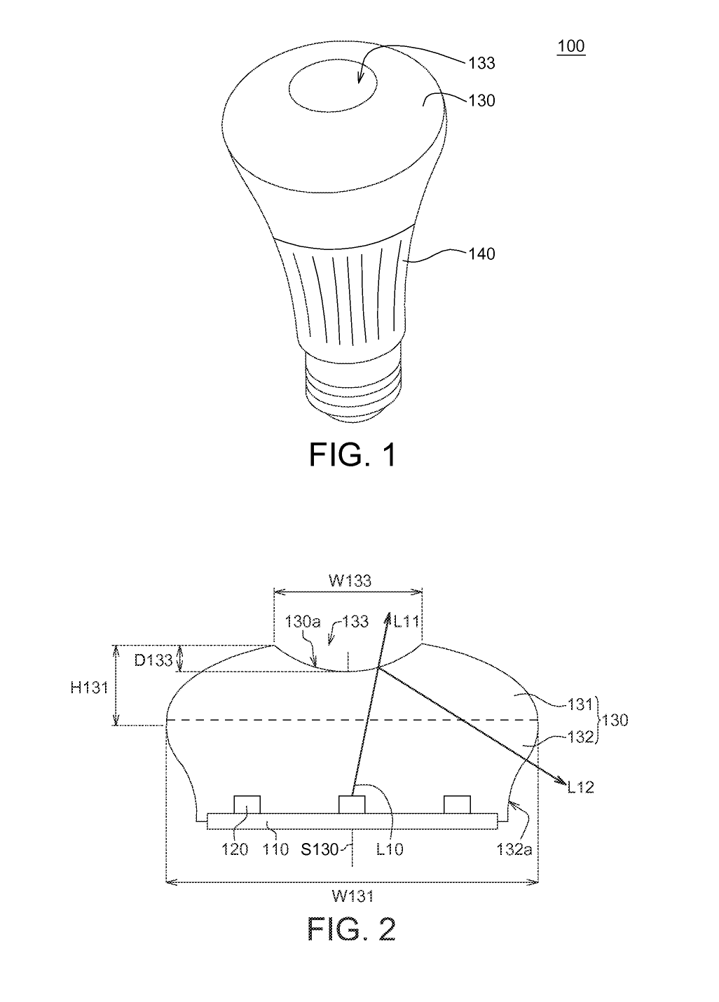

Please referring to FIGS. 1 and 2, FIG. 1 shows a light emitting diode (LED) lamp 100 according to a first embodiment and FIG. 2 shows a cross section view of a diffusing cap 130 in FIG. 1. The LED lamp 100 comprises a circuit board 110, at least one LED 120, the diffusing cap 130 and a heat sink structure 140.

The circuit board 110 is used for carrying varied electronic elements. For example, the circuit board 110 may be a hard printed circuit board or a flexible printed circuit board.

The LED 120 is used for emitting a light. For example, the LED 120 may be an AlGaInP LED or a GaN LED. The number of the at least one LED 120 may be one or more than one. In the present embodiment, the number of the at least one LED 120 is plurality. Each LED 120 is disposed on the circuit board 110 for emitting a light L10. Each LED 120 has high directivity, so the emission angle of each LED 120 is small.

The diffusing cap 130 is used for guiding and diffusing the light L10 emitted from the LED 120. For example, the diffusing cap 130 may include a transparent material and a plurality of diffusing particles. The transparent material may be polystyrene (PS), polymethylmethacrylate (PMMA) or polycarbonate (PC). The diffusing particles may be SiO₂ particles or TiO₂ particles. In the present embodiment, the diffusing cap 130 covers each LED 120 and the circuit board 110 for guiding and diffusing the light L10 to be emitted at a wide emission angle.

The heat sink structure 140 is used for dissipating a heat. For example, the heat sink structure 140 may be an aluminum fin, a fan or a liquid channel. In the present embodiment, the heat sink structure 140 is disposed below the circuit board 110 for dissipating a heat generated from the LED 120 and the circuit board 110.

When the light L10 is emitted from the LED 120, the light L10 is guided to a top surface 130a of the diffusing cap 130. Part of the light L11 passes through the top surface 130a of the diffusing cap 130 and part of the light L12 is reflected by the top surface 130a.

The diffusing cap 130 includes an outer emitting portion 131 and a lateral emitting portion 132. The lateral emitting portion 132 is connected to the outer emitting portion 131 of the diffusing cap 130 and the heat sink structure 140. The outer emitting portion 131 has a concave 133 located above the LED 120. The concave 133 may be arc shaped. The concave 133 is located at a center of the outer emitting portion 131.

Due to the shape of the concave 133, the reflected light L12 can be reflected toward a lateral surface 132a of the lateral emitting portion 132. Especially, the reflected light L12 will not hidden by the circuit board 110. As such, not only the top of the LED lamp 100 can emit the light L11, but also the lateral side of the LED lamp 100 can emit the light L12.

The concave 133 is symmetrical to a central axis S130 of the diffusing cap 130. Therefore, all of the reflected lights L12 are averagely reflected to the lateral surface 132a of the lateral emitting portion 132.

Regarding to a depth D133 of the concave 133, a ratio of the depth D133 of the concave 133 to a height H131 of the outer emitting portion 131 may be 0.1 to 0.2. In the present embodiment, the ratio of the depth D133 of the concave 133 to the height H131 of the outer emitting portion 131 is 0.13.

Regarding to a maximum width W133 of the concave 133, a ratio of the maximum width W133 of the concave 133 to a maximum width W131 of the outer emitting portion 131 is 0.2 to 0.4. In the present embodiment, the ratio of the maximum width W133 of the concave 133 to the width W131 of a bottom of the outer emitting portion 131 is 0.4.

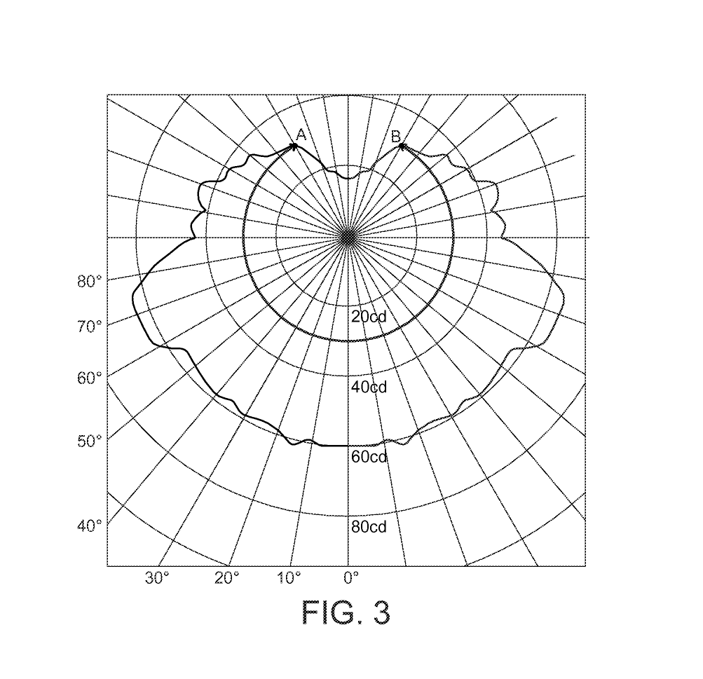

Please referring to FIG. 3, a light intensity plot of the LED lamp 100 in FIGS. 1 and 2 is shown. The max light intensity of the LED lamp 100 is 60 Candela (cd). The half of the max light intensity of the LED lamp 100 is 30 cd. The half-intensity light angle of the LED lamp 100 ranging from point A to point B is 290°. That is to say, the concave 133 can greatly enlarge the half-intensity

### Second Embodiment

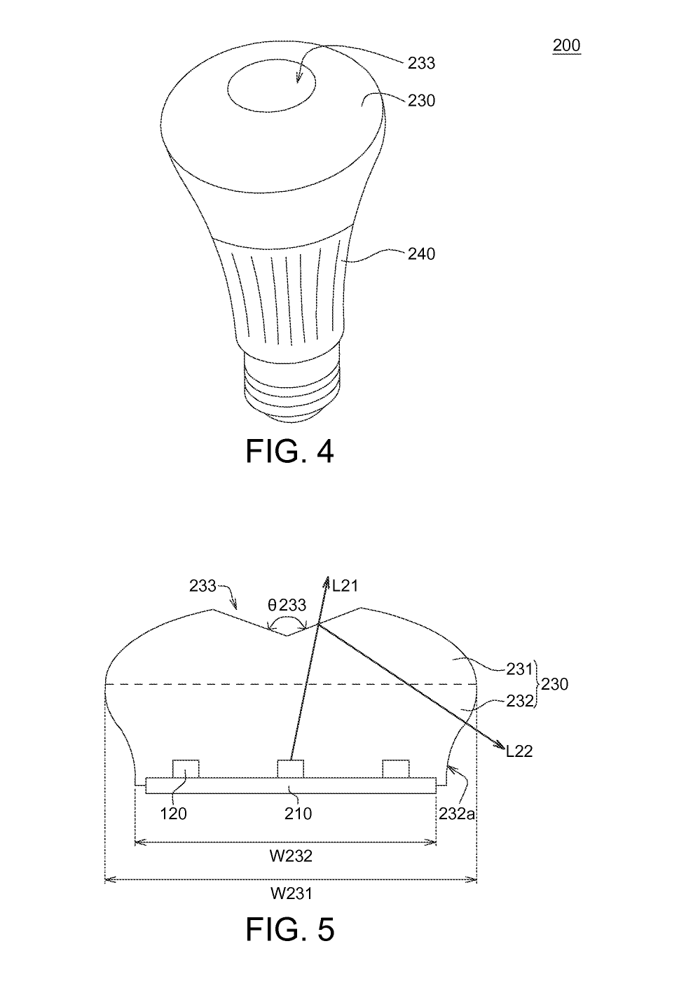

Please referring to FIGS. 4 and 5, FIG. 4 shows a light emitting diode (LED) lamp 200 according to a second embodiment, and FIG. 5 shows a cross section view of a diffusing cap 230 in FIG. 4. The LED lamp 200 of the present embodiment is different from the LED lamp 100 of the first embodiment in the shape of a concave 233, and the similarities are not repeated here.

Referring to FIG. 5, the diffusing cap 230 includes an outer emitting portion 231 and a lateral emitting portion 232. The outer emitting portion 231 has a concave 233. The lateral emitting portion 232 is connected to the outer emitting portion 231. The concave 233 is pyramidal. Due to the shape of the concave 233, the reflected light L22 can be reflected toward a lateral surface 232a of the lateral emitting portion 232. Especially, the reflected light L22 will not hidden by the circuit board 210. As such, not only the top of the LED lamp 200 can emit light L21, but also the lateral side of the LED lamp 200 can emit light L22.

Regarding the relationship between the outer emitting portion 231 and the lateral emitting portion 232, a ratio of a width W231 of a bottom of the outer emitting portion 231 to a width W232 of a bottom of the lateral emitting portion 232 may be 1.2 to 1.4. In the present embodiment, the ratio of the width W231 of the bottom of the outer emitting portion 231 to the width W232 of the bottom portion 232 is 1.33.

Regarding to the angle θ233 of a tip of the concave 233, the angle θ233 is 140° to 160°. In the present embodiment, the angle θ233 is 155°.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting diode (LED) lamp, comprising:
a circuit board;
at least one LED, disposed on the circuit board for emitting a light;
a diffusing cap, covering the LED and the circuit board, wherein the diffusing cap includes:
an outer emitting portion, having a concave; and
a lateral emitting portion, connected to the outer emitting portion, wherein the concave is used for reflecting part of the light toward a lateral surface of the lateral emitting portion; and
a heat sink structure, connected to the lateral emitting portion of the diffusing cap.

2. The LED lamp according to claim 1, wherein the concave is arc shaped.

3. The LED lamp according to claim 1, wherein a ratio of a depth of the concave to a height of the outer emitting portion is 0.1 to 0.2.

4. The LED lamp according to claim 1, wherein a ratio of a depth of the concave to a height of the outer emitting portion is 0.13.

5. The LED lamp according to claim 1, wherein a ratio of a maximum width of the concave to that of the outer emitting portion is 0.2 to 0.4.

6. The LED lamp according to claim 1, wherein a ratio of a maximum width of the concave to that of the outer emitting portion is 0.4.

7. The LED lamp according to claim 1, wherein the concave is pyramidal.

8. The LED lamp according to claim 7, wherein an angle of a tip of the concave is 140° to 160°.

9. The LED lamp according to claim 1, wherein the concave is located at a center of the outer emitting portion of the diffusing cap.

10. A diffusing cap used in a light emitting diode (LED) lamp, the diffusing cap comprising:
an outer emitting portion, having a concave; and
a lateral emitting portion, connected to the outer emitting portion, wherein the concave is used for reflecting part of a light emitted from at least one LED toward a lateral surface of the lateral emitting portion.

11. The diffusing cap according to claim 10, wherein the concave is arc shaped.

12. The diffusing cap according to claim 10, wherein a ratio of a depth of the concave to a height of the outer emitting portion is 0.1 to 0.2.

13. The diffusing cap according to claim 10, wherein a ratio of a depth of the concave to a height of the outer emitting portion is 0.13.

14. The diffusing cap according to claim 10, wherein a ratio of a maximum width of the concave to that of the outer emitting portion is 0.2 to 0.4.

15. The diffusing cap according to claim 10, wherein a ratio of a maximum width of the concave to that of the outer emitting portion is 0.4.

16. The diffusing cap according to claim 10, wherein the concave is pyramidal.

17. The diffusing cap according to claim 16, wherein an angle of a tip of the concave is 140° to 160°.

18. The diffusing cap according to claim 10, wherein the concave is located at a center of the outer emitting portion of the diffusing cap.
